(19) United States
(12) Patent Application Publication
(10) Pub. No.: US 2008/0151137 A1
(43) Pub. Date: Jun. 26, 2008

(54) LAMP UNIT AND BACKLIGHT UNIT AND LIQUID CRYSTAL DISPLAY USING THE SAME

(75) Inventors: Byeong-Soo KANG, Cheonan (KR); Nam-Soo KANG, Ansan (KR); Seung-Jae KANG, Cheonan (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/933,293

(22) Filed: Oct. 31, 2007

(30) Foreign Application Priority Data
Dec. 22, 2006 (KR) 10-2006-0132961

(51) Int. Cl. G02F 1/13357; F21V 1/02; F21V 8/00

(52) U.S. Cl. 349/58; 362/296; 362/632

(57) ABSTRACT

The present invention relates to a lamp unit, a backlight unit, and a display using the same, and more particularly, to a lamp unit having a wire receiving section formed in a lamp cover, a backlight unit, and a liquid crystal display (LCD) using the same. The present invention may provide a lamp unit, where wiring arrangement work can be easily performed and an assembling process can be simplified by forming a wire receiving section in the lamp cover to receive wires; a backlight unit; and an LCD using the lamp unit. Further, the present invention may provide a lamp unit, where a lamp unit and an inverter are integrally manufactured, whereby a process of mounting the inverter and wiring arrangement work is not required when a LCD is assembled, thus simplifying the manufacturing process; a backlight unit; and an LCD using the lamp unit. Furthermore, the present invention may provide a lamp unit, whereby a connector for connecting an inverter and wires is not required, reducing the manufacturing costs; a backlight unit; and a LCD using the lamp unit.

### CROSS REFERENCE TO RELATED APPLICATIONS

This application claims priority from and the benefit of Korean Patent Application No. 10-2006-0132961, filed on Dec. 22, 2006, which is hereby incorporated by reference for all purposes as if fully set forth herein.

### BACKGROUND OF THE INVENTION

1. Field of the Invention

The present invention relates to a lamp unit, a backlight unit, and a display using the same, and more particularly, to a lamp unit having a wire receiving section formed in a lamp cover, and a backlight unit and a liquid crystal display using the same.

2. Discussion of the Background

The liquid crystal display (LCD) has been widely used in many applications because the LCD has a lightweight structure, has a slim shape, requires minimal power consumption, provides full-color implementation and high resolution. LCDs are used in computers, notebooks, personal digital assistants (PDAs), telephones, television sets, and audio/video devices. Depending upon image signals applied to a plurality of switches arranged in a matrix pattern, the light transmissivity of a LCD is controlled to display a desired image on a LCD panel.

Unlike a plasma display, the LCD does not have a self light-emitting structure; thus, the LCD may include a backlight unit having a light source. The backlight unit may be classified according to the location of the light source. Thus, a backlight unit may be classified into an edge-type backlight unit where the light source is positioned in a side portion of the backlight unit, or a direct-type backlight unit where the light source is positioned in a lower portion of the backlight unit.

The edge-type backlight unit may use a light-emitting diode or a lamp unit according to the type of light source. The edge-type backlight unit includes a lamp unit, a light guide plate located in a side portion of the lamp unit, an optical sheet provided over or under the light guide plate, and a mold frame for receiving and securing the edge-type backlight unit components.

In addition, the lamp unit includes a lamp, a lamp cover for reflecting the light emitted from the lamp to a light incident section of the light guide plate, wires for connecting the lamp, and an inverter for supplying suitable power to the lamp.

Currently, the mold frame is formed with a groove for holding the wires. However, due to a limitation of the structure of the mold frame, it is difficult and troublesome to position the wires in the groove even though the groove is formed in the mold frame, making it difficult to assemble the backlight unit.

### SUMMARY OF THE INVENTION

The present invention provides a lamp unit that may be easier to assemble and cheaper to manufacture, and a backlight unit and a liquid crystal display using the lamp unit.

Additional features of the invention will be set forth in the description which follows, and in part will be apparent from the description, or may be learned by practice of the invention.

The present invention discloses a lamp unit including a lamp; a wire electrically connected to the lamp; and a lamp cover to reflect light emitted from the lamp, where the lamp cover includes a lamp receiving section to receive the lamp and a wire receiving section to receive the wire.

The present invention also discloses a backlight unit including a light guide plate; and a lamp unit disposed at a side of the light guide plate, where the lamp unit includes a lamp, a wire electrically connected to the lamp, and a lamp cover to reflect light emitted from the lamp, wherein the lamp cover includes a lamp receiving section to receive the lamp and a wire receiving section to receive the wire, the wire receiving section extending from the lamp receiving section.

The present invention also discloses a liquid crystal display including a backlight unit, which includes a light guide plate and a lamp unit disposed at a side of the light guide plate, where the lamp unit includes a lamp, a wire electrically connected to the lamp and a lamp cover to reflect light emitted from the lamp, where the lamp cover includes a lamp receiving section to receive the lamp and a wire receiving section to receive the wire, and where the wire receiving section extends from the lamp receiving section; and a liquid crystal display panel to receive the light emitted from the backlight unit to display an image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of this specification, illustrate embodiments of the invention, and together with the description serve to explain the principles of the invention.

FIG. 1 is a perspective view of a lamp unit according to a first exemplary embodiment of the present invention.

FIG. 2 is a sectional view taken along line A-A of FIG. 1.

FIG. 3 shows sectional views of lamp covers according to modified exemplary embodiments of the present invention.

FIG. 4 is a perspective view of a lamp unit according to a second exemplary embodiment of the present invention.

FIG. 5(a) is a sectional view taken along line B-B of FIG. 4.

FIG. 5(b) is a sectional view taken along line C-C of FIG. 4.

FIG. 6 is a perspective view of a lamp unit according to a third exemplary embodiment of the present invention.

FIG. 7 is a sectional view taken along line D-D of FIG. 6.

FIG. 8 is a schematic exploded perspective view of a backlight unit according to the first exemplary embodiment of the present invention.

FIG. 9 is a schematic sectional view showing the backlight unit taken along line E-E of FIG. 8 in an assembled state.

FIG. 10 is a schematic exploded perspective view of a backlight unit according to the second exemplary embodiment of the present invention.

FIG. 11 is a sectional view showing the backlight unit taken along line F-F of FIG. 10 in an assembled state.

FIG. 12 is a schematic exploded perspective view of a liquid crystal display according to a third exemplary embodiment of the present invention.

FIG. 13 is a sectional view showing the liquid crystal display taken along line G-G of FIG. 12 in an assembled state.

### DETAILED DESCRIPTION OF THE ILLUSTRATED EMBODIMENTS

The invention is described more fully hereinafter with reference to the accompanying drawings, in which embodiments of the present invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

It will be understood that when an element such as a layer, film, region or substrate is referred to as being “on”, “connected to”, or “coupled to” another element or layer, it can be directly on, directly connected to, or directly coupled to the other element or layer, or intervening elements or layers may also be present. In contrast, when an element is referred to as being “directly on”, “directly connected to”, or “directly coupled to” another element or layer, there are no intervening elements or layers present.

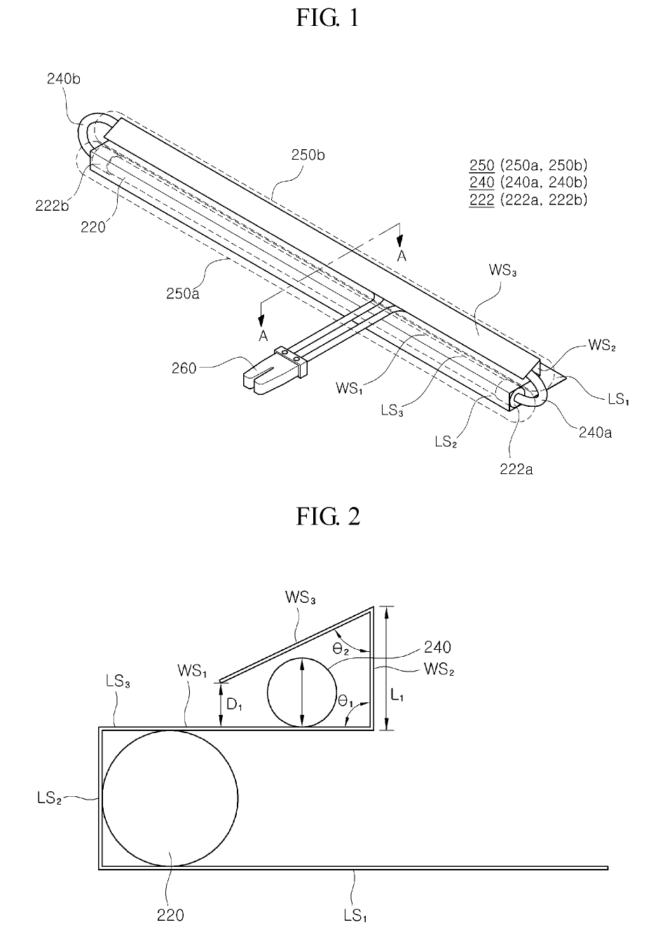

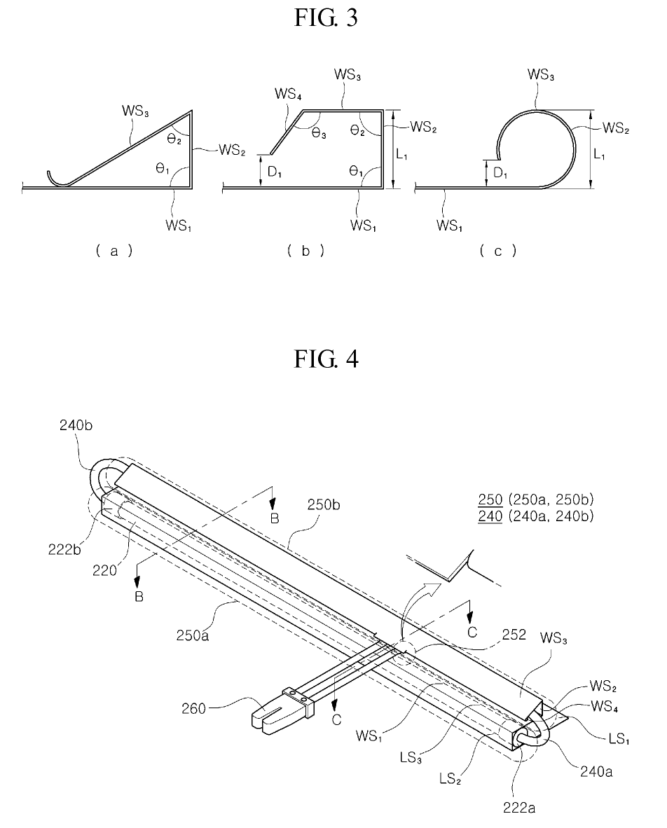

FIG. 1 is a perspective view of a lamp unit according to a first exemplary embodiment of the present invention, FIG. 2 is a sectional view taken along line A-A of FIG. 1, and FIG. 3 shows sectional views of lamp covers according to modified exemplary embodiments of the present invention.

As shown in FIG. 1 and FIG. 2, a lamp unit according to the first exemplary embodiment of the present invention includes lamp 220, lamp sockets 222 formed on lamp 220, wires 240 connected to lamp sockets 222, and lamp covers 250 for reflecting the light emitted from lamp 220.

According to an exemplary embodiment of the present invention, lamp 220, which is a light source of the lamp unit, may be a cold cathode fluorescent lamp (CCFL). The CCFL includes a glass tube, an inert gas injected in the glass tube, and cathode and anode electrodes respectively installed at both ends of the glass tube. An inner surface of the glass tube is coated with a phosphor, where the phosphor is stimulated by ultraviolet radiation emitted from the inert gas, causing an emission of visible light to the outside of the CCFL.

Lamp sockets 222 supply power to lamp 220 and affix lamp 220 to lamp cover 250, include first lamp socket 222a and second lamp socket 222b respectively formed at the ends of lamp 220. Lamp sockets 222a and 222b include insulative members and conductive electrodes (not shown) formed on the insulative members. The conductive electrodes may also include first and second electrodes (not shown) respectively formed in first and second lamp sockets 222a and 222b. Thus, first lamp socket 222a is formed with the first electrode connected to the cathode electrode of lamp 220, and second lamp socket 222b is formed with the second electrode connected to the anode electrode of lamp 220 for applying external power to the lamp.

Wires 240 supply power to lamp 220. Wires 240 include first wire 240a and second wire 240b. First wire 240a and second wire 240b are connected to a wiring connector, and the wiring connector may be coupled with an output connector of an inverter (not shown). First wire 240a connected to the wiring connector may connect the first electrode of first lamp socket 222a and the first electrode of the output connector in the inverter, and second wire 240b connected to the wiring connector may connect the second electrode of second lamp socket 222b and a second electrode of the output connector in the inverter.

Lamp cover 250 reflects the light emitted from lamp 220, but does not immediately radiate the light to a light exit region of lamp cover 250, and subsequently re-emits the light to the light exit region. Lamp cover 250 includes lamp receiving section 250a and wire receiving section 250b.

Lamp receiving section 250a, which receives lamp 220 therein, includes first lamp receiving surface LS₁, second lamp receiving surface LS₂ extending at a certain angle from one end of first lamp receiving surface LS₁, and third lamp receiving surface LS₃ extending at a certain angle from one end of second lamp receiving surface LS₂ opposite to the end of LS₂ connected to first lamp receiving surface LS₁. Second lamp receiving surface LS₂ may extend perpendicular to first lamp receiving surface LS₁, and third lamp receiving surface LS₃ may extend parallel with and overlap first lamp receiving surface LS₁. Thus, lamp receiving section 250a surrounds lamp 220. However, it is preferred that the lamp receiving section 250a be formed in a “X ” shape to permit the light emitted from lamp 220 to be incident on a light incident surface of a light guide plate (not shown), which will be described below.

However, lamp receiving section 250a may be formed in any shape, such as a round shape, that allows the light emitted from lamp 220 to be reflected to the light exit region of lamp cover 250.

In this exemplary embodiment, wire receiving section 250b, which receives wires 240, is formed on lamp receiving section 250a. Wire receiving section 250b includes first wire receiving surface WS₁, second wire receiving surface WS₂ extending at a certain angle, i.e., a first angle θ₁, from one end of first wire receiving surface WS₁, and third wire receiving surface WS₃ extending at a certain angle, i.e., a second angle θ₂, from an end of second wire receiving surface WS₂ opposite to the end of WS₂ connected to first wire receiving surface WS₁.

In this exemplary embodiment, lamp receiving section 250a includes first, second, and third lamp receiving surfaces LS₁, LS₂, and LS₃ for reflecting the light emitted from the lamp 220, and wire receiving section 250b includes first, second, and third wire receiving surfaces WS₁, WS₂, and WS₃ for receiving wires 240. Third lamp receiving surface LS₃ and first wire receiving surface WS₁ overlap each other, so that two surfaces are brought into contact with wires 240 and lamp 250, respectively.

The first angle θ₁ may be a right angle and the second angle θ₂ may be an acute angle. Further, the second angle θ₂ may be an acute angle so that a first distance D₁, which is a distance between the free end of third wire receiving surface WS₃ and first wire receiving surface WS₁ is shorter than a first length L₁, which is a vertical length of second wire receiving surface WS₂. The first distance D₁ may be smaller than a diameter of each wire 240 received in wire receiving section 250b. Wire 240 having a diameter larger than the first distance D₁ passes through a space between first wire receiving surface WS₁ and third wire receiving surface WS₃ due to the elasticity of wire receiving section 250b, and is then received in wire receiving section 250b. Thus, lamp cover 250 may be made of a material such as a metal having elasticity and high flexibility.

In addition, although FIG. 2 shows the free end of third wire receiving surface WS₃, i.e., the region in contact with received wires 240, is flat, the shape is not limited thereto. The end of third wire receiving surface WS₃ may be formed in a variety of shapes allowing for wires 240 to be easily received in wire receiving section 250b.

Thus, as shown in FIG. 3(a), first wire receiving surface WS₁ meets second wire receiving surface WS₂ at the first angle θ₁, second wire receiving surface WS₂ meets third wire receiving surface WS₃ at the second angle θ₂, and the free end of third wire receiving surface WS₃ is curved. Thus, it is possible to prevent wires 240 from being damaged. As shown in FIG. 3(a), although the free end of third wire receiving surface WS₃ may be curved in an outward direction, a shape is not limited thereto. Thus, the free end of third wire receiving surface WS₃ may be curved in an inward direction.

In addition, as shown in FIG. 3(b), one end of third wire receiving surface WS₃ may be bent at a third angle θ₃ toward first wire receiving surface WS₁ to define fourth wire receiving surface WS₄, where the first distance D₁ is smaller than the first length L₁.

Also, as shown in FIG. 3(c), second and third wire receiving surfaces WS₂ and WS₃ may be curved. In this case, the wire receiving surfaces should be formed so that the first distance D₁ is smaller than the first length L₁.

Further, in wire receiving section 250b, third wire receiving surface WS₃ is not formed on the entire end of second wire receiving surface WS₂, but may be formed only on a portion of the end of second wire receiving surface WS₂. For example, third wire receiving surface WS₃ may be formed only on both sides of second wire receiving surface WS₃ that are also both sides of wire receiving section 250b and a region thereof to be exposed so that wires 240 are connected to the inverter.

Thus, if the first distance D₁ is smaller than the first length L₁, wires 240 may be received within wire receiving section 250b of lamp cover 250. Received wires 240 may have any cross section of a polygonal shape or a round shape including a circular shape.

Here, first lamp receiving surface LS₁ and third lamp receiving surface LS₃ may correspond to a mounting surface of the light guide plate (not shown) to affix the lamp unit to the light guide plate when the lamp unit is mounted to the light guide plate.

In this exemplary embodiment, the light emitted from the lamp 220 toward the lamp receiving section 250a is reflected on a surface of the lamp receiving section 250a and then emitted through the light exit region of the lamp cover 250. However, the present invention is not limited thereto. That is, a reflecting member, e.g., a reflection sheet (not shown) may be additionally provided between the lamp receiving section 250a and the lamp 220, so that the light emitted from the lamp 220 is reflected on the reflection sheet and then emitted through the light exit region of the lamp cover 250. The reflection sheet may be attached to the lamp receiving section 250a.

In the lamp unit according to this exemplary embodiment, wire receiving section 250b is formed on lamp cover 250a and wires 240 are received in wire receiving section 250b, simplifying the arrangement of wires 240 and the assembly of the lamp unit.

Next, a lamp unit according to a second exemplary embodiment of the present invention will be described with reference to the drawings. Descriptions for the backlight unit of the second exemplary embodiment overlapping those of the lamp unit according to the first exemplary embodiment will be omitted or briefly explained.

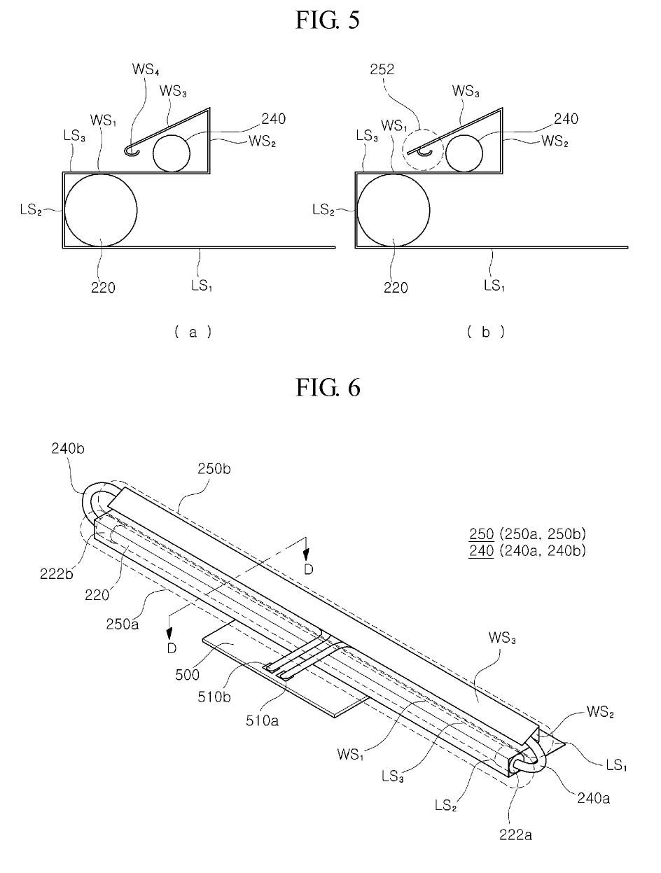

FIG. 4 is a perspective view of the lamp unit according to a second exemplary embodiment of the present invention, FIG. 5(a) is a sectional view taken along line B-B of FIG. 4, and FIG. 5(b) is a sectional view taken along line C-C of FIG. 4.

As shown in FIG. 4, FIG. 5(a), and FIG. 5(b), the lamp unit according to the second exemplary embodiment of the present invention includes lamp 220, lamp sockets 222 formed on lamp 220, wires 240 connected to lamp sockets 222, and lamp cover 250 reflecting the light emitted from lamp 220 and having a wire exposing section 252.

Wires 240 supply power to the lamp 220. Wires 240 include first wire 240a and second wire 240b. Wiring connector 260 may be connected to first wire 240a and second wire 240b. Wiring connector 260 may also be connected to an output connector of an inverter (not shown).

Lamp cover 250 reflects the light emitted from lamp 220, but does not immediately radiate the light to a light exit region of lamp cover 250, and subsequently re-emits the light to the light exit region. Lamp cover 250 includes lamp receiving section 250a and wire receiving section 250b.

Lamp receiving section 250a, which receives lamp 220 therein, may be formed in a “ [symbol] ” shape to permit the light emitted from lamp 220 to be incident on a light incident surface of a light guide plate (not shown), which will be described below.

However, lamp receiving section 250a may be formed in any shape, such as a round shape, that allows the light emitted from lamp 220 to be incident on the light incident surface of the light guide plate.

Further, a reflecting member, e.g., a reflection sheet may be provided between the lamp receiving section 250a and the lamp 220.

Wire receiving section 250b, which receives wires 240, may be formed on lamp receiving section 250a as described in the aforementioned exemplary embodiment.

According to this exemplary embodiment, lamp cover 250 includes wire exposing section 252 formed on a portion of third wire receiving surface WS₃ for exposing one end of each wire 240 connected to the inverter.

Wire exposing section 252 may be formed by bending a region of one end of third wire receiving surface WS₃ opposite to the other end thereof adjacent to one end of second wire receiving surface WS₂ in a direction where wires 240 are received. Thus, a region of third wire receiving surface WS₃, except the region on which wire exposing section 252 will later be formed, is bent to define fourth wire receiving surface WS₄, securing wires 240 received in wire receiving section 250b. Also, wires 240 are exposed through wire exposing section 252 on which fourth wire receiving surface WS₄ is not defined, thereby connecting wires 240 to the inverter (not shown).

As described above, when wires 240 are exposed through wire exposing section 252 for connecting wires 240 to the inverter, a portion of wires 240 are received within wire receiving section 250b, simplifying the arrangement of wires 240 and the assembly of the lamp unit.

Next, a lamp unit according to a third exemplary embodiment of the present invention will be described with reference to the drawings. Descriptions for the backlight unit of the third exemplary embodiment overlapping the foregoing descriptions will be omitted or briefly explained.

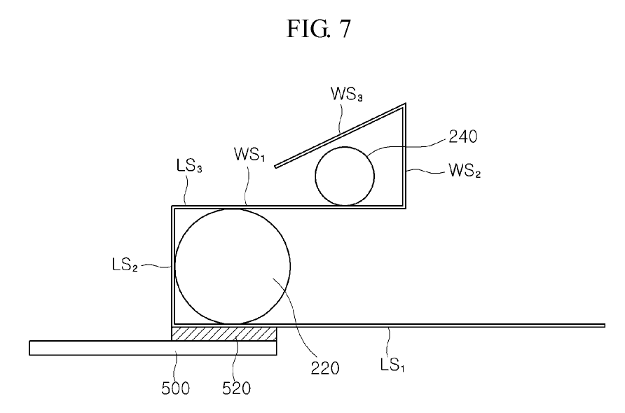

FIG. 6 is a perspective view of the lamp unit according to a third exemplary embodiment of the present invention, and FIG. 7 is a sectional view taken along line D-D of FIG. 6.

As shown in FIG. 6 and FIG. 7, a lamp unit according to the third exemplary embodiment of the present invention includes lamp 220, lamp sockets 222 formed on lamp 220, wires 240 connected to the lamp sockets 222, lamp cover 250 for reflecting the light emitted from lamp 220, and inverter 500 connected to wires 240.

Inverter 500, which converts supplied external power into power suitable for lamp 220, includes a power converting unit mounted to a substrate, a power input unit connected to the power converting unit for supplying power to be converted by the power converting unit, and first output pad 510a and second output pad 510b for outputting the converted power to lamp 220.

Wires 240 supply power to lamp 220. Wires 240 include first wire 240a and second wire 240b. In this exemplary embodiment, a connector is not provided. First wire 240a may connect a first electrode (not shown) of the first lamp socket 222a connected to an anode electrode (not shown) of lamp 220 and first output pad 510a of the inverter, and second wire 240b may connect a second electrode (not shown) of the second lamp socket 222b connected to a cathode electrode (not shown) of lamp 220 and second output pad 510b of the inverter.

In this exemplary embodiment, inverter 500 of the lamp unit is attached to lamp cover 250.

Thus, inverter 500 may be attached to first lamp receiving surface LS₁ using adhesive member 520, such as a double-sided adhesive tape. Lamp 220 may be electrically connected to inverter 500 by respectively connecting first and second output pads 510a and 510b of inverter 500 to first and second wires 240a and 240b.

First output pad 510a of inverter 500 may be connected to first wire 240a by a method such as soldering, and second output pad 510b may be connected to second wire 240b through the same method. However, the present exemplary embodiment is not limited thereto. Thus, as for the lamp unit according to the first exemplary embodiment of the present invention described above, first and second wires 240a and 240b may be formed with first and second wiring connectors (not shown), and first and second inverter connectors (not shown) are formed instead of first and second output pads 510a and 510b, whereby the first and second wiring connectors and the first and second inverter connectors can be respectively connected.

As described above, in the lamp unit according to this exemplary embodiment, inverter 500 may be attached to lamp cover 250 and may be connected to wires 240 by soldering, preventing the need for a connector to connect inverter 500 and wires 240. As a result, manufacturing costs may be reduced.

Next, a backlight unit according to the first exemplary embodiment of the present invention will be described with reference to the drawings. Descriptions for the backlight unit of the first exemplary embodiment overlapping the foregoing descriptions will be omitted or briefly explained.

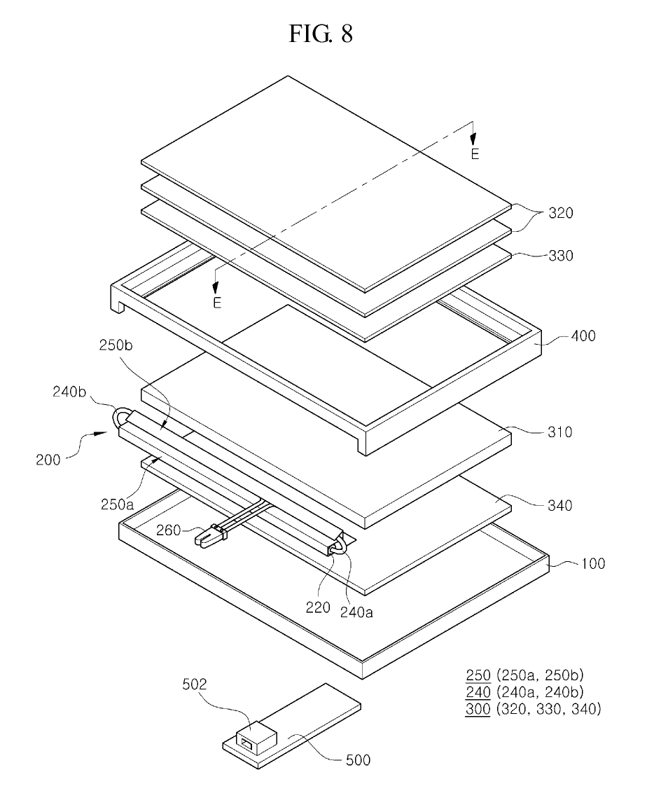

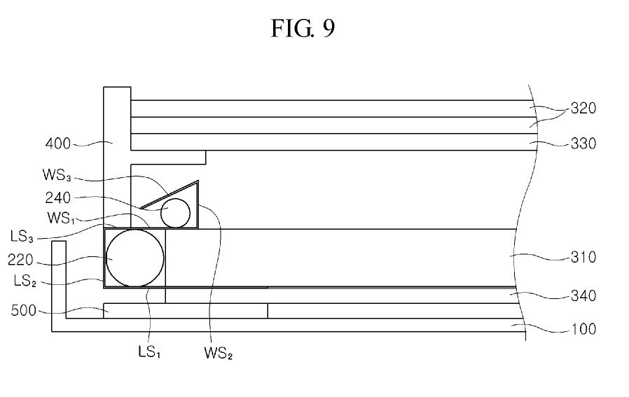

FIG. 8 is a schematic exploded perspective view of the backlight unit according to the first exemplary embodiment of the present invention, and FIG. 9 is a schematic sectional view showing the backlight unit taken along line E-E of FIG. 8 in an assembled state.

As shown in FIG. 8 and FIG. 9, the backlight unit according to the first exemplary embodiment of the present invention includes lamp unit 200; inverter 500 for supplying power to lamp unit 200; light guide plate 310 provided at a side of lamp unit 200; optical sheets 300 provided over light guide plate 310; mold frame 400 for fixing the location of lamp unit 200, light guide plate 310, and the optical sheets 300; and lower receiving member 100 for receiving lamp unit 200, the light guide plate 310, and optical sheets 300 which are fixed in position by mold frame 400.

Inverter 500, converts supplied external power into power suitable for lamp unit 200, includes a power converting unit mounted to a substrate, a power input unit connected to the power converting unit for supplying the power to be converted by the power converting unit, and a power output unit, i.e., inverter connecter 502 for outputting the power to be converted. Inverter 500 is connected to lamp unit 200 through wires 240.

Lamp unit 200 includes lamp 220, lamp sockets (not shown) formed on lamp 220, wires 240 connected to the lamp sockets, and lamp cover 250 for reflecting the light emitted from lamp 220.

Wires 240 supply power to lamp 220. Wires 240 include first wire 240a and second wire 240b. One end of first wire 240a is connected to a first electrode of a first lamp socket and one end of second wire 240b is connected to a second electrode of a second lamp socket. In addition, a wiring connector is formed at the other ends of first and second wires 240a and 240b to be connected to inverter connector 502 of the inverter.

Lamp cover 250 reflects the light emitted from lamp 220, but does not immediately enter a light incident surface of light guide plate 310, and subsequently causes the light to be incident on light guide plate 310. Lamp cover 250 may include lamp receiving section 250a and wire receiving section 250b.

Preferably, lamp receiving section 250a, which receives lamp 220 therein, is formed in a “ [symbol] ” shape to permit the light emitted from lamp 220 to be incident on the light incident surface of light guide plate 310. Further, since lamp receiving section 250a is formed in a “ [symbol] ” shape, first lamp receiving surface LS₁ and third lamp receiving surface LS₃ may be brought into contact with light guide plate 310 and serve to fix lamp unit 200.

However, the shape of lamp receiving section 250a is not limited thereto, but may be formed in a round shape. Thus, lamp receiving section 250a may be formed in any shape that can make the light emitted from lamp 220 be incident on the light incident surface of light guide plate 310.

Preferably, wire receiving section 250b, which receives wires 240, is formed on lamp receiving section 250a as in the aforementioned exemplary embodiments. Thus, it is preferred that wire receiving section 250b is formed on lamp receiving section 250a in order not to prevent the light emitted from lamp 220 received in lamp receiving section 250a from being incident on the light incident surface of light guide plate 310. As described above, if wire receiving section 250b is formed on lamp receiving section 250a and lamp cover 250 is mounted to light guide plate 310, wire receiving section 250b is placed on top of light guide plate 310. In addition, since wire receiving section 250b is formed on lamp receiving section 250a as described above, wire receiving section 250b is positioned in an inner space of mold frame 400, which is a marginal space formed when the backlight unit is assembled.

In the backlight unit according to the present invention as described above, the wiring arrangement work can be easily performed by modifying only a shape of the lamp cover 250 without changing a shape of the existent mold frame, thereby simplifying the assembling process.

According to this exemplary embodiment, optical sheets 300, which improve the quality of the light emitted from lamp unit 200 and enhance light efficiency, may include diffusion sheet 330 and prism sheets 320.

Diffusion sheet 330 uniformly diffuses the light emitted from lamp unit 200 and transfers the diffused light to prism sheets 320 and a LCD panel (not shown), which will be described below, to increase a viewing angle and to reduce diffusion of bright spots, bright lines, and stains. Preferably, diffusion sheet 330 is placed over light guide plate 310.

Prism sheets 320 refract and concentrate the light emitted from the lamp unit to increase luminance and emit the light toward the LCD panel (not shown). Thus, it is preferable that prism sheets 320 be placed between diffusion sheet 330 and the LCD panel (not shown).

Reflection sheet 340, which reflects the light leaking from a bottom surface of light guide plate 310 and causes the reflected light to enter the LCD panel (not shown), may be placed under light guide plate 310.

Lower receiving member 100 may be formed in the shape of a hexahedral box having an opened upper face and a receiving space with a predetermined depth formed in lower receiving member 100. Lower receiving member 100 may include a bottom surface and sidewalls extending and bending perpendicularly from edges of the bottom surface.

Next, a backlight unit according to a second exemplary embodiment of the present invention will be described with reference to the drawings. Descriptions for the backlight unit of the second exemplary embodiment overlapping those of the backlight unit according to the first exemplary embodiment will be omitted or briefly explained.

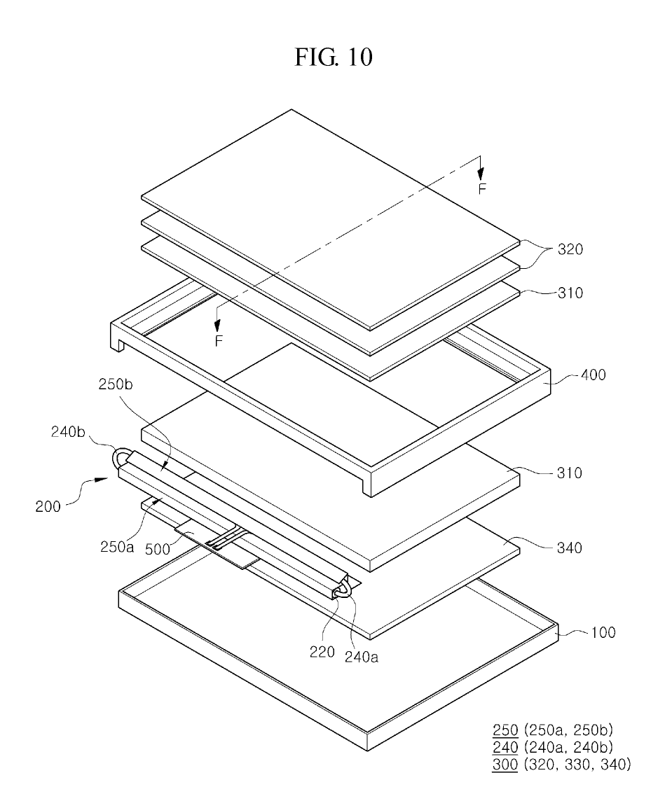

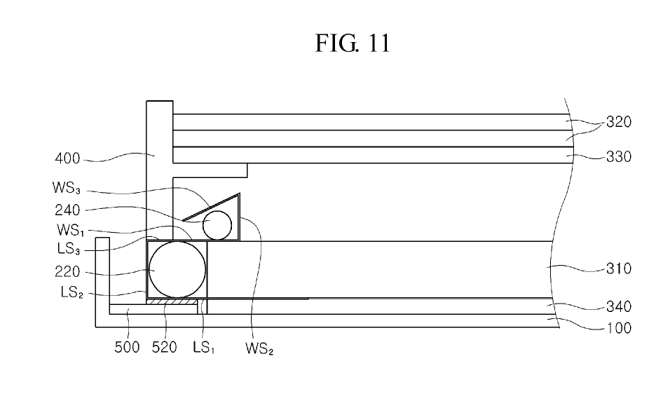

FIG. 10 is a schematic exploded perspective view of a backlight unit according to a second exemplary embodiment of the present invention, and FIG. 11 is a sectional view showing the backlight unit taken along line F-F of FIG. 10 in an assembled state.

As shown in FIG. 10 and FIG. 11, the backlight unit according to the second exemplary embodiment of the present invention includes lamp unit 200 attached to inverter 500; light guide plate 310 provided at a side of lamp unit 200; optical sheets 300 provided over light guide plate 310, mold frame 400 for fixing the location of lamp unit 200, light guide plate 310, and optical sheets 300; and lower receiving member 100 for receiving lamp unit 200, light guide plate 310, and optical sheets 300, which are fixed by mold frame 400.

Lamp unit 200 includes lamp 220, lamp sockets (not shown) formed on lamp 220, wires 240 connected to the lamp sockets, lamp cover 250 for reflecting the light emitted from lamp 220, and inverter 500 attached to lamp cover 250.

In lamp unit 200 according to this exemplary embodiment, inverter 500 is attached to first lamp receiving surface LS₁ of lamp cover 250. Thus, inverter 500 may be attached to an outer surface of first lamp receiving surface LS₁, which is opposite to wire receiving section 250b, using an adhesive member 520, such as a double-sided adhesive tape. In addition, wires 240 connected to the lamp sockets are connected to inverter 500 by a method such as soldering, so that the power outputted from inverter 500 can be applied to lamp 220.

As described above, when inverter 500 is manufactured, inverter 500 is attached to lamp cover 250 adjacent to lamp 220, and wires 240 connecting inverter 500 and lamp 220 are received in lamp receiving section 250b formed in lamp cover 250, so that inverter 500 and lamp unit 200 are integrally formed. Thus, a process of mounting the inverter 500 and the wiring arrangement work is not required when the backlight unit is assembled, simplifying the manufacturing process of a backlight unit.

In addition, wires 240 and inverter 500 are soldered to each other, preventing the need for a connector to connect inverter 500 and wires 240 and reducing the manufacturing costs of the backlight unit.

Next, an LCD using the backlight unit according to the aforementioned exemplary embodiment will be described with reference to the drawings. Descriptions for the backlight unit overlapping the foregoing descriptions will be omitted or briefly explained.

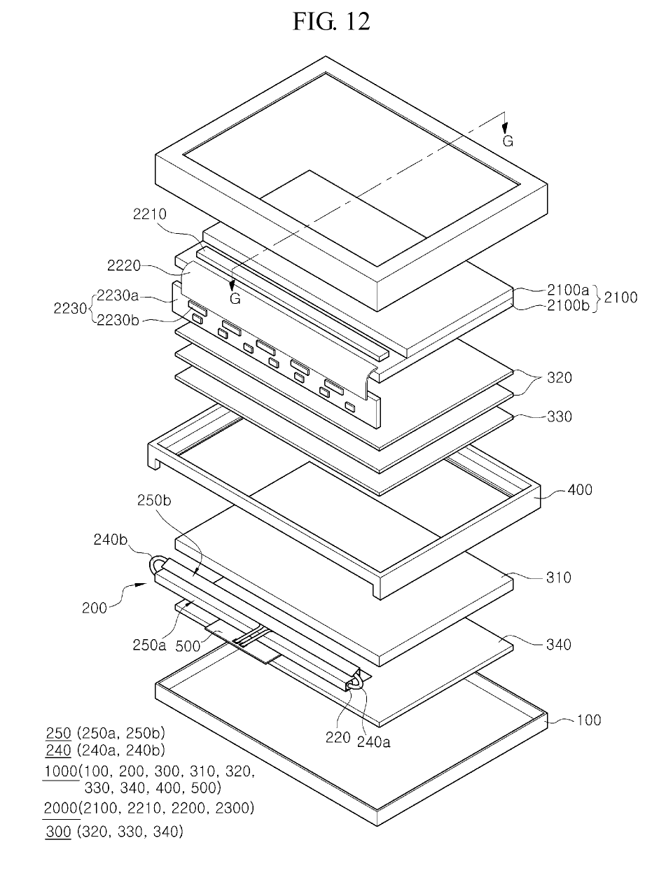

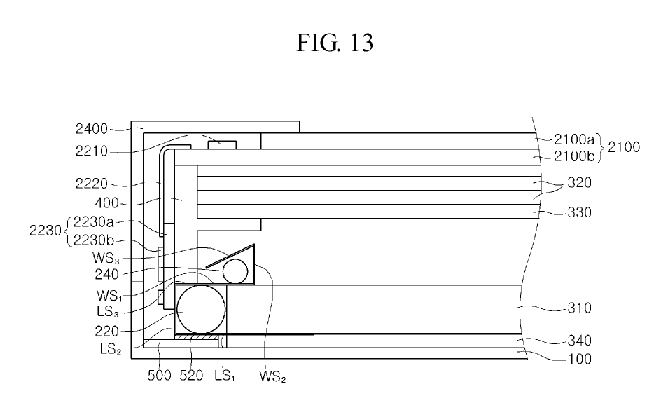

FIG. 12 is a schematic exploded perspective view of a liquid crystal display according to an exemplary embodiment of the present invention, and FIG. 13 is a sectional view showing the liquid crystal display taken along line G-G of FIG. 12 in an assembled state.

As shown in FIG. 12 and FIG. 13, the LCD according to an exemplary embodiment of the present invention includes LCD panel 2000, a backlight unit 1000 provided under the LCD panel 2000, and upper receiving member 2400 for surrounding a certain region of an upper portion and side portions of LCD panel 2000 and backlight unit 1000.

LCD panel 2000, which displays an image thereon, includes thin film transistor substrate 2100b and color filter substrate 2100a bonded on thin film transistor substrate 2100b. Further, LCD panel 2000 may further include panel board assembly 2230, which is electrically connected to LCD panel 2000 and LCD panel driving unit 2210, and has a variety of circuit components 2230b mounted on substrate 2230a.

Preferably, thin film transistor substrate 2100b is a transparent, insulative substrate, on which a plurality of pixel areas in the form of a matrix are defined, and includes thin film transistors provided in the pixel areas and pixel electrodes. Thin film transistor substrate 2100b may include a display region overlapping color filter substrate 2100a, displaying an image; a non-display region exposed to the outside when thin film transistor substrate 2100b is bonded to color filter substrate 2100a; and LCD panel driving unit 2210 mounted thereon. Source terminals of the thin film transistors are electrically connected to data lines extending in one direction, and gate terminals are electrically connected to gate lines extending in a direction perpendicular to the data lines. A drain terminal is electrically connected to each pixel electrode provided in the pixel area and is formed of a transparent conductive material, such as indium tin oxide (ITO) or indium zinc oxide (IZO).

Preferably, color filter substrate 2100a is a transparent, insulative substrate on which pixel areas corresponding to thin film transistor substrate 2100b are defined, and includes a common electrode and color filters provided in the pixel areas. Preferably, the color filters and the common electrode are provided in the pixel areas corresponding to the pixel electrodes. It is effective that the common electrode is provided on an entire surface of color filter substrate 2100a. Preferably, a black matrix pattern is provided on color filter substrate 2100 for preventing light leakage. A common voltage is applied to the common electrode. Backlight unit 1000 includes lamp unit 200 provided with inverter 500; light guide plate 310 provided at a side of lamp unit 200; optical sheets 300 provided over and under light guide plate 310 to improve the quality of the light emitted from lamp unit 220 and enhance light efficiency; mold frame 400 for fixing lamp unit 200 and optical sheets 300; and lower receiving member 100 for receiving lamp unit 200, optical sheets 300, and mold frame 400.

Lamp unit 200 includes lamp 220, lamp sockets (not shown) formed on lamp 220, wires 240 connected to the lamp sockets, lamp cover 250 reflecting the light emitted from lamp 220 and including lamp receiving section 250a and wire receiving section 250, and inverter 500 attached to lamp cover 250 and connected to the lamp sockets through wires 240.

Inverter 500, which converts supplied external power into power suitable for the lamp unit 200, includes a power converting unit mounted to a substrate, a power input unit connected to the power converting unit for supplying the power to be converted to the power converting unit, and a power output unit for outputting the converted power.

Inverter 500 may be attached to first lamp receiving surface LS₁ using an adhesive member 520, such as a double-sided adhesive tape. In addition, inverter 500 and wire 400 may be connected to each other through a connecter. However, the present invention is not limited thereto, but inverter 500 and the wire 400 may be connected to each other by a method such as soldering without a connector.

In backlight unit 1000 according to this exemplary embodiment as described above, inverter 500 is attached to lamp cover 250 to be fixed in position and inverter 500 is soldered to wires 240, preventing the need for a connector to connect inverter 500 and wires 240 and reducing the manufacturing costs of the backlight unit.

Further, lamp unit 200 and inverter 500 are integrally manufactured, so that a process of mounting inverter 500 and the wiring arrangement work is not required when the LCD is assembled, simplifying the manufacturing process of the backlight unit.

Furthermore, wire receiving section 250b is formed on lamp receiving section 250a so that wire receiving section 250b is received in an inner space of mold frame 400 which is a marginal space formed when the backlight unit is assembled, and wires 240 are received in wire receiving section 250b. Accordingly, the wiring arrangement work can be easily performed by modifying only a shape of lamp cover 250 without changing a shape of the existing mold frame 400, thereby simplifying the assembling process.

Mold frame 400 is formed in the shape of a rectangular frame and includes a plane portion and sidewall portions bent from the plane portion at a right angle. A seating section (not shown) may be formed on the plane portion in order for LCD panel 2000 to be seated. Fixing protrusions brought into contact with edge surfaces of LCD 2000 and aligning the LCD panel may be used as the seating section, or the seating section may be formed to have stepped surfaces. Optical sheets 300 and guide plate 310 mounted with lamp unit 200 are fixed to mold frame 400.

Upper receiving member 2400 is formed in the shape of a rectangular frame having a plane portion and sidewall portions bent from the plane portion at a right angle. A lower portion of the plane portion of upper receiving member 2400 partially supports the edges of the LCD panel and the sidewall portions are coupled with the sidewalls of lower receiving member 100 while facing them. Preferably, upper receiving member 2400 and lower receiving member 100 are made of a metal having excellent strength, a lightweight structure, and small deformation.

As described above, the present invention may provide a lamp unit, wherein wiring arrangement work can be easily performed and an assembling process can be simplified by forming a wire receiving section in the lamp cover to receive wires; a backlight unit; and a LCD using the lamp unit.

In addition, the present invention may provide a lamp unit, wherein a wire receiving section is formed on a lamp receiving section so that the wire receiving section is received in an inner space of a mold frame, which is a marginal space formed when a backlight unit is assembled, and wires are received in the wire receiving section, whereby wiring arrangement work can be easily performed by modifying only a shape of a lamp cover without changing a shape of an existent mold frame, thus simplifying an assembling process; a backlight unit; and a LCD using the lamp unit.

Further, the present invention may provide a lamp unit, wherein a lamp unit and an inverter are integrally manufactured, whereby a process of mounting the inverter and wiring arrangement work is not required when a LCD is assembled, thus simplifying the manufacturing process; a backlight unit; and a LCD using the lamp unit.

Furthermore, the present invention may provide a lamp unit, where a connector for connecting an inverter and wires is not required, thus reducing the manufacturing cost; a backlight unit; and a LCD using the lamp unit.

Although exemplary embodiments of the present invention have been shown and described in detail hereinabove, it should be clearly understood that many variations and/or modifications of the basic inventive concepts taught herein, which may appear to those skilled in the present art, will still fall within the scope and spirit of the present invention. Thus, it is intended that the present invention cover the modifications and variations of this invention provided they come within the scope of the appended claims and their equivalents.

What is claimed is:

1. A lamp unit, comprising:
a lamp;
a wire electrically connected to the lamp; and
a lamp cover to reflect light emitted from the lamp,
wherein the lamp cover comprises a lamp receiving section to receive the lamp and a wire receiving section to receive the wire, and the wire receiving section surrounds at least a portion of the wire.

2. The lamp unit of claim 1, wherein the wire receiving section extends from the lamp receiving section

3. The lamp unit of claim 1, wherein the wire receiving section is bent and comprises an opening, the wire entering the wire receiving section through the opening.

4. The lamp unit of claim 3, wherein the wire receiving section comprises a receiving region to receive the wire and an entering region open for the wire to enter the receiving section, wherein the entering region comprises a width smaller than a width of the receiving region.

5. The lamp unit of claim 4, wherein the receiving region comprises a width equal to or larger than a diameter of the wire.

6. The lamp unit of claim 4, wherein the entering region comprises a width smaller than a diameter of the wire.

7. The lamp unit of claim 4, wherein the wire receiving section comprises a cross section of a polygonal shape or a rounded shape.

8. The lamp unit of claim 1, wherein the lamp cover comprises a metal having elasticity and high flexibility.

9. The lamp unit of claim 1, further comprising an inverter attached to the lamp cover and electrically connected to the lamp through the wire.

10. The lamp unit of claim 9, wherein the inverter comprises a power converting section, a power inputting section connected to the power converting section to input power to be converted into the power converting section, and an output section to output the power converted by the power converting section.

11. The lamp unit of claim 10, wherein the output section comprises an output pad, the output pad being soldered to the wire.

12. The lamp unit of claim 10, wherein the output section comprises an output connector, the output connector being coupled to a wiring connector formed at an end of the wire.

13. The lamp unit of claim 9, wherein the inverter is attached to the lamp receiving section by means of an adhesive member.

14. A backlight unit, comprising:
a light guide plate; and
a lamp unit disposed at a side of the light guide plate, the lamp unit comprising:
a lamp,
a wire electrically connected to the lamp, and
a lamp cover to reflect light emitted from the lamp, wherein the lamp cover comprises a lamp receiving section to receive the lamp and a wire receiving section to receive the wire, the wire receiving section extending from the lamp receiving section.

15. The backlight unit of claim 14, wherein the lamp cover extends in a longitudinal direction from the light guide plate.

16. The backlight unit of claim 14, wherein the wire receiving section is formed on the lamp receiving section and arranged on top of the light guide plate.

17. The backlight unit of claim 14, further comprising an inverter electrically connected to the lamp through the wire.

18. The backlight unit of claim 17, further comprising a reflection sheet which is provided between the lamp cover and the lamp, wherein the inverter is attached to a surface of the lamp receiving section opposite to the wire receiving section by means of an adhesive member.

19. A liquid crystal display, comprising:
a backlight unit comprising:
a light guide plate and a lamp unit disposed at a side of the light guide plate,
wherein the lamp unit comprises a lamp, a wire electrically connected to the lamp and a lamp cover to reflect light emitted from the lamp, wherein the lamp cover comprises a lamp receiving section to receive the lamp and a wire receiving section to receive the wire, and wherein the wire receiving section extends from the lamp receiving section; and
a liquid crystal display panel to receive the light emitted from the backlight unit to display an image.
